(19) United States
(12) Patent Application Publication
(10) Pub. No.: US 2005/0178744 A1
(43) Pub. Date: Aug. 18, 2005

(54) Electrical discharge machining electrode

(75) Inventor: Kiyoshi Suzuki, Yokohama (JP)

Correspondence Address: MCDERMOTT WILL & EMERY LLP, 18191 VON KARMAN AVE., IRVINE, CA, 92612-7107, US

(73) Assignees: Sodick Co., Ltd.; Koyishi Suzuki

(21) Appl. No.: 10/840,251

(22) Filed: May 7, 2004

(30) Foreign Application Priority Data
Feb. 17, 2004 (JP) JP 2004-040548

(51) Int. Cl. B23H 1/06

(52) U.S. Cl. 219/69.15; 427/585

(57) ABSTRACT

An electrode used for electrical discharge machining of a workpiece, where the electrode comprises electrically-conductive diamond having a maximum specific resistivity of 1×10⁻³Ω·m. The electrically-conductive diamond further has a thermal diffusivity of at least 0.23×10⁻³ m²/s. In an alternative arrangement, the electrode comprises boron-doped, electrically-conductive diamond.

### FIELD OF THE INVENTION

The present invention relates generally to electrical discharge machining (“EDM”), and more particularly relates to an improved, low-wear electrode for use in sinker EDM, in which a current is applied across a gap formed between the electrode and a workpiece.

### BACKGROUND OF THE INVENTION

Electrical discharge machining is a thermal metal removal process using a series of electric sparks to erode material from a workpiece. EDM works by applying a current across a gap formed between an electrode and a workpiece which is immersed in a dielectric fluid, and generating a spark across the gap.

Typical EDM electrodes for roughing and finishing are made of materials such as copper, graphite, or copper tungsten. Since ordinary EDM electrodes also wear during the EDM process, an electrode wear ratio is calculated for each electrode type, where the electrode wear ratio is defined as the amount of wear on the EDM electrode, divided by the amount of wear on the workpiece. EDM with an electrode wear ratio of less than 1% is considered “low-wear” or “no-wear” machining, since the electrode is wearing at a far slower rate than the workpiece.

Low-wear machining can be obtained by modifying a variety of conditions, such as electrode or workpiece material composition, dielectric fluid type, and power generator conditions such as polarity, a peak current and duration of a current pulse. In order to perform low-wear machining, the current pulse must have a longer than average duration. In particular, in order to rough-machine a cathodic workpiece with low-wear on a typical anodic copper or graphite electrode, a current pulse having a peak of tens or hundreds of amperes must be applied across the gap, for hundreds or thousands of microseconds.

In the typical case where a current pulse has a long duration, the thermal decomposition of dielectric oil causes carbon to be generated as a by-product. This carbon adheres to the conventional electrode as a protective layer, effectuating the low-wear effect.

It is difficult to perform low-wear machining when using a small electrode (an electrode having a machining area of 5 millimeters square or less) or when increasing surface roughness, since low-wear machining can only be performed under a limited range of power settings. Specifically, under low-wear conditions, surface roughness can only be increased to 6 μRy, since the current peak is limited to 3 amperes, or 2 ampere average current. Furthermore, using a small electrode, when on-times are set to several or tens of microseconds, the current peak is limited to 10 amperes or less. Under these circumstances, carbon does not adhere to the electrode, and multiple electrodes must be used to complete a single task.

The manufacture of electrodes costs a great deal of money, and the replacement of spent electrodes reduces positioning accuracy. In conventional small-area machining, copper-tungsten electrodes are used, which are characterized by a high resistance to spark impact and resistance to wear on the corners, but these electrodes have an inferior total electrode wear ratio.

Accordingly, it is desirable to provide for an electrical discharge machining electrode which is resistant to wear under various power settings. Additionally, it is desirable to provide for an electrical discharge machining electrode which effectuates the adhesion of carbon to the electrode to allow “low-wear” effect even under short pulse conditions with on-time of 30 μs or less.

### SUMMARY OF THE INVENTION

According to one aspect, the present invention is an electrode used for electrical discharge machining of a workpiece, where the electrode comprises electrically-conductive diamond having a maximum specific resistivity of 1×10⁻³Ω·m. The electrically-conductive diamond further has a thermal diffusivity of at least 0.23×10⁻³ m²/s.

According to a second aspect, the present invention is an electrode used for electrical discharge machining of a workpiece, where the electrode comprises boron-doped, electrically-conductive diamond.

According to a third aspect, the present invention is a method of producing an electrode for electrical discharge machining of a workpiece. The method includes the steps of producing a synthetic diamond by chemical vapor deposition, and doping boron to the synthetic diamond.

According to a fourth aspect, the present invention is a method of electrical discharge machining a workpiece. The method comprises the step of generating electrical discharge between the workpiece and an electrode, where the electrode comprises electrically-conductive diamond having a maximum specific resistivity of 1×10⁻³Ω·m. The electrically-conductive diamond has a thermal diffusivity of at least 0.23×10⁻³ m²/s.

According to a fifth aspect, the present invention is a method of electrical discharge machining a workpiece. The method includes the steps of forming a work gap, by positioning an electrically-conductive diamond electrode close to the workpiece, and applying current pulse having on-time of at least 30 μs across the work gap, from a power generator. The electrode wear ratio is 1% or less. The method further includes the steps of connecting the electrically-conductive diamond electrode to a positive pole of the power generator, and connecting the workpiece to a negative pole of the power generator.

In the following description of the preferred embodiment, reference is made to the accompanying drawings that form a part thereof, and in which is shown by way of illustration a specific embodiment in which the invention may be practiced. It is to be understood that other embodiments may be utilized and changes may be made without departing from the scope of the present invention.

### BRIEF DESCRIPTION OF THE DRAWINGS

Referring now to the drawings in which like reference numbers represent corresponding parts throughout:

FIG. 1 is a table showing the properties of the electrically-conductive CVD diamond;

FIG. 2(a) shows micrographs of the machined workpiece and the used electrodes after the workpiece was machined under the conditions recommended for copper electrode;

FIG. 2(b) shows micrographs of the machined workpiece and the used electrodes after the workpiece was machined under the conditions recommended for graphite electrode;

FIG. 3 shows micrographs of the machined workpiece and the used electrodes after the workpiece was machined under the short pulse conditions;

FIGS. 4(a) and 4(b) show micrographs of the used electrodes after the workpiece was machined under the short pulse conditions;

FIG. 5 shows micrographs of the workpiece machined under the short pulse conditions;

FIG. 6 shows micrographs of the machined workpiece and the used electrodes after the workpiece was machined under the short pulse conditions;

FIG. 7 is a graph showing material removal rate as a function of current density;

FIG. 8 is a graph showing material removal rate as a function of on-time and off-time;

FIG. 9 is a graph showing electrode wear as a function of current peak; and

FIG. 10 is a graph showing material removal rate as a function of current peak.

### DETAILED DESCRIPTION OF THE INVENTION

According to the present invention, an electrically-conductive diamond thick film suitable for an EDM electrode is produced by doping boron or a similar material to a synthetic diamond. The synthetic diamond is formed by high pressure synthesis, chemical vapor deposition (“CVD”) synthesis or similar process. The electrically-conductive diamond has properties such as a low specific resistivity, high thermal diffusivity and high temperature oxidation resistance [+α° C.], as well as beneficial properties characteristic of synthetic diamonds, such as hardness, elastic modulus, corrosion resistance and thermal conductivity. The thermal diffusivity [m²/s] of the electrically-conductive diamond thick film is represented by Equation (1). In Equation (1), α represents the thermal diffusivity, λ represents the thermal conductivity, Cp represents the specific heat, and p represents the density.
α=λ/Cp·p Equation (1)

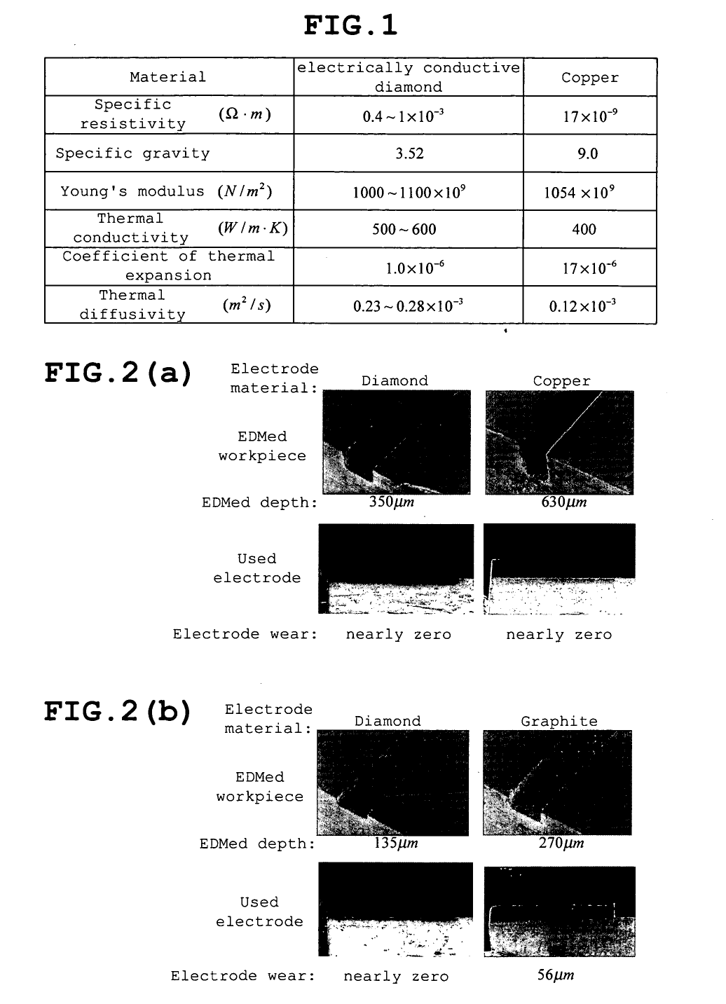

FIG. 1 is a table showing the properties of the electrically-conductive CVD diamond and copper, for comparison. Although the selection of an electrode material makes a key difference for EDM performance, new electrode materials are rarely proposed, and the conventional materials (copper, graphite, and copper tungsten) still predominate the electrode field.

Ideally, the selected electrode material should possess a high electrical conductivity and high thermal diffusivity. CVD diamond thick film has a high electrical conductivity, as demonstrated by a maximum specific resistivity ρ of 0.4˜1×10⁻³Ω·m, as well as a high thermal diffusivity of at least 0.23˜0.28×10⁻³ m²/s, making CVD diamond ideal for use as an EDM electrode. Although conventional diamonds can only be machined using diamond grits, electrically-conductive diamonds can be formed to almost any shape using EDM.

Experiments have been conducted to compare the performances of electrically-conductive diamond electrodes to conventional electrodes, under various conditions. During these experiments, an electrically-conductive CVD diamond thick film segment measuring 5 mm×6 mm×0.5 mm was configured as an electrode, and was mounted on the head of a sinker EDM machine using an appropriate electrode holder.

The diamond film was synthesized in the vapor phase by microwave plasma enhanced CVD. During the CVD synthesis; diamond crystals grew on the substrate in the presence of methane in hydrogen gas at the deposition temperature of over 2000° C. Although the CVD diamond is essentially pure carbon with no binder phase, the CVD diamond is truly a polycrystalline diamond since it is formed as intergrown diamond microcrystallites. A synthetic diamond having thick columnar structures is formed by the intergrowth of the polycrystalline diamond grits. Electrically conductivity of the synthetic diamond is introduced by boron doping, where the process of boron doping is well known in the art. See International Publication No. WO 00/73543; see also Element Six Advanced Diamond, http://www.e6.com.

In prior experiments, a workpiece of a high speed steel, such as Japanese Industrial Standard (“JIS”) steels SKH51 and HRC63, was fixed on an appropriate surface of the machine. An electrode was connected to a positive pole of a power generator while the workpiece was connected to a negative pole thereof. The electrically-conductive diamond electrode was positioned close to the workpiece to form a work gap between the electrode and the workpiece, and the work gap was filled with commercially available oil, such as Vitol 2, available from the Sodick Co., Ltd., as the dielectric oil.

The workpiece was electrical discharge machined, with a machined area of 1.5 mm² (3 mm×0.5 mm) for 10 minutes under the recommended conditions for copper electrode. A reverse polarity (with an electrode being positively charged and a workpiece being negatively charged) was set, open circuit voltage uᵢ was set to 90 V, current peak iₑ was set to 1.5 A, on-time tₑ was set to 20 μs, and off-time tₒ was set to 15 μs. The current peak iₑ is a peak of current pulse which is supposed to flow in the power supply circuit if the work gap is short-circuited. As shown in FIG. 2(a), the machined depth was 350 μm with electrode wear of nearly zero. Next, the workpiece was electrical discharge machined using a copper electrode for 10 minutes under the same conditions. The machined depth was 630 μm with copper electrode wear of nearly zero, as shown in FIG. 2(a).

The workpiece was then electrical discharge machined for 10 minutes under the recommended conditions for graphite electrode. A reverse polarity was set, open circuit voltage uᵢ was set to 90 V, current peak iₑ was set to 3 A, on-time tₑ was set to 12 μs, and off-time tₒ was set to 7 μs. As shown in FIG. 2(b), the machined depth was 135 μm with electrode wear of nearly zero. Next, the workpiece was electrical discharge machined using a graphite electrode for 10 minutes under the same conditions. As illustrated in FIG. 2(b), the machined depth was 270 μm with graphite electrode wear of 56 μm. In the case of electrically-conductive diamond electrode, although the material removal rate was half that of the copper and graphite electrodes, superior control of the shape of the electrical discharge machined groove was obtained, along with a very low-wear of the diamond electrode.

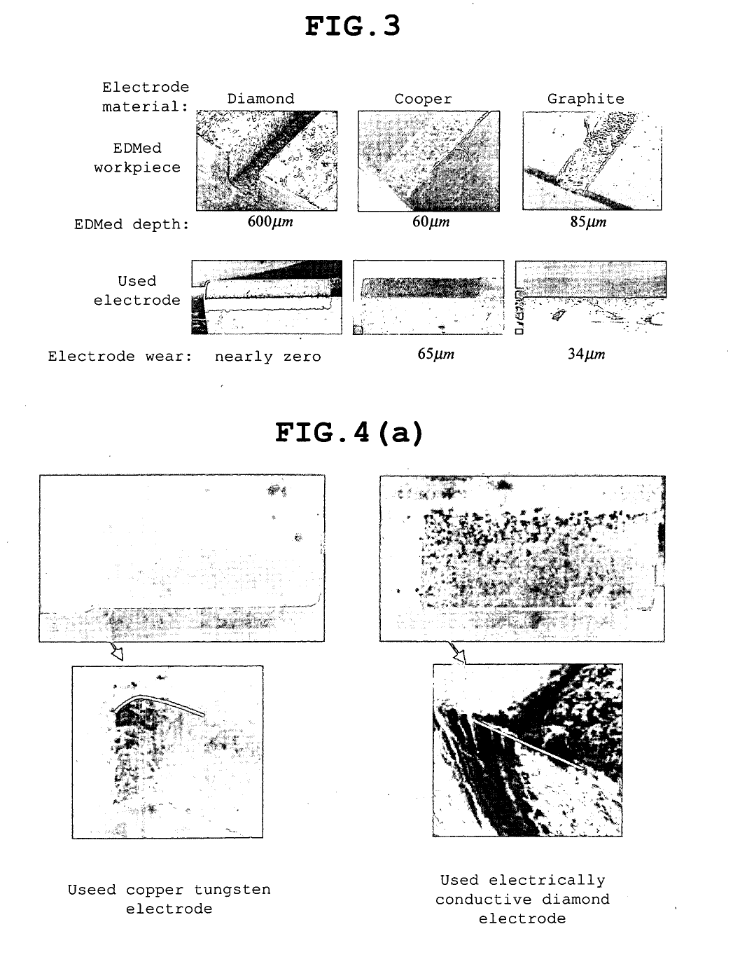

The finishing conditions with short on-time were tried on electrically-conductive diamond, copper, graphite and copper tungsten electrodes. A reverse polarity was set, open circuit voltage uᵢ was set to 120 V, current peak iₑ was set to 4 A, on-time tₑ was set to 6 μs, off-time tₒ was set to 50 μs, and the machining time was 10 minutes. The deep groove of 600 μm depth can be machined with electrode wear of nearly zero, as shown in FIG. 3. In the case of copper electrode, the machined depth was 60 μm with electrode wear of 65 μm. In the case of graphite electrode, the machined depth was 85 μm with electrode wear of 34 μm. The workpiece of JIS steel SKD11 was electro discharge machined using an electrically-conductive diamond electrode and a copper tungsten electrode under the same finishing conditions.

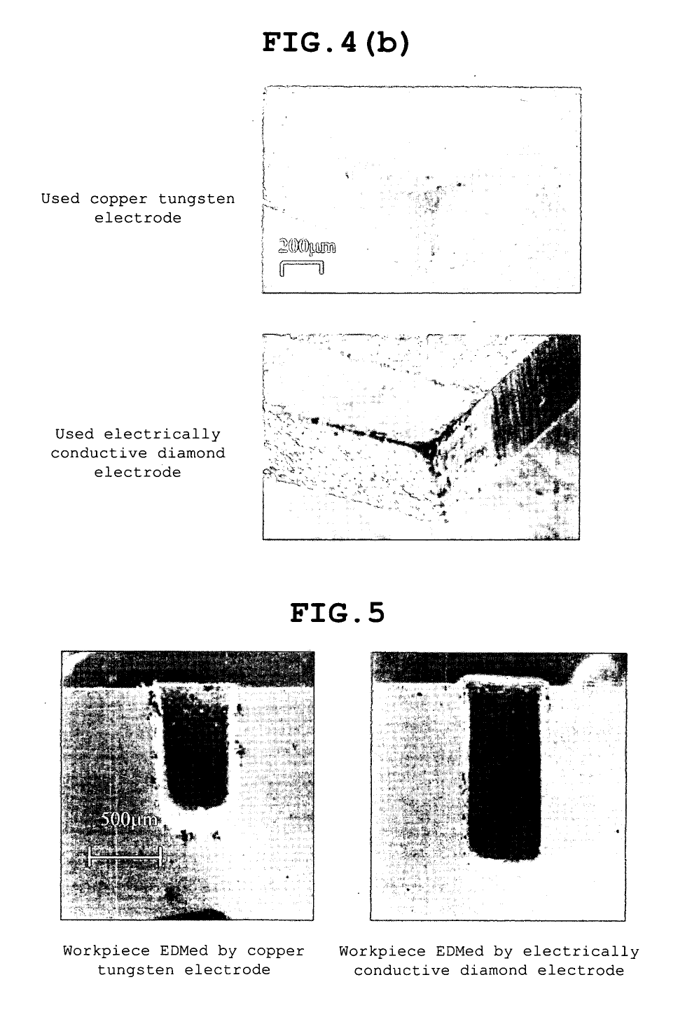

A copper tungsten electrode is typically used for finishing. FIG. 4 shows small wear of the used copper tungsten electrode and almost no wear of the used electrically-conductive diamond electrode. As shown in FIG. 5, the used electrically-conductive diamond electrode still had sharp corner and edges while the corner and edges of the copper tungsten electrode became rounded. Carbon seems to be generated by thermal decomposition of dielectric oil, and adhered to the electrically-conductive diamond electrode.

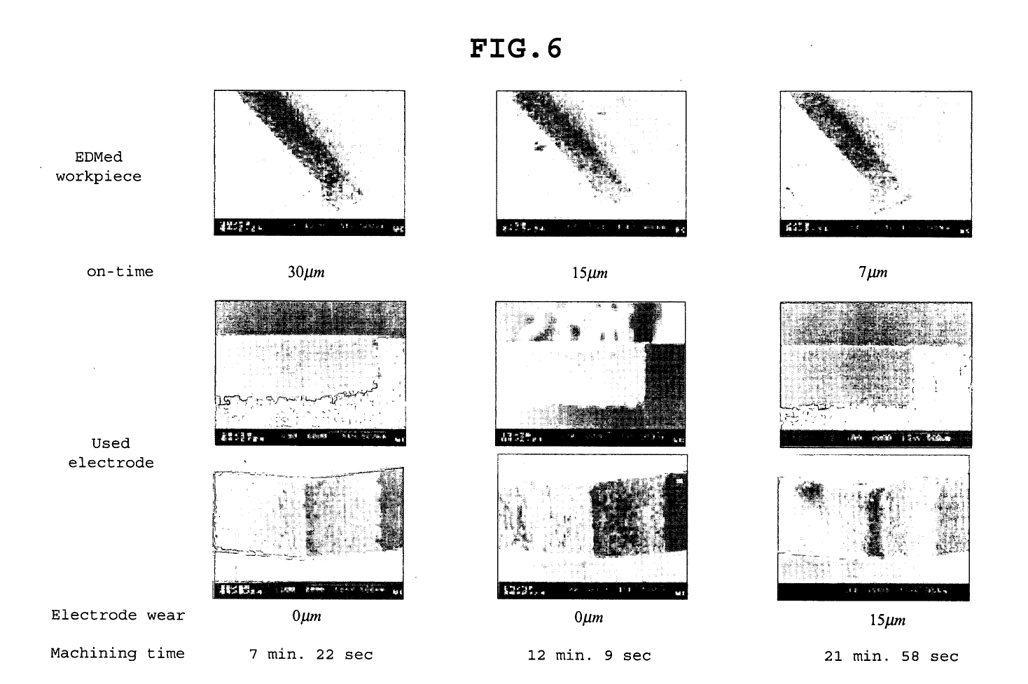

As shown in FIG. 6, when the electrically-conductive diamond electrode was used, the deeper groove which is exactly complementary in shape to the unworn electrode was formed. Though another experiment was made on the electrically-conductive diamond electrode further shortening on-time tₑ from 6 μs to 3 μs and current peak iₑ from 4 A to 1.5 A, no electrode wear was observed.

Additionally, the workpiece of a sintered hard alloy was electrical discharge machined under the finishing conditions. A reverse polarity was set, open circuit voltage uᵢ was set to 90 V, current peak iₑ was set to 6 A, and off-time tₒ was set to 50 μs. As shown in FIG. 6, even when on-time was set to 30 μs and 15 μs, low-wear effect was obtained. Thus, the electrically-conductive diamond electrode is preferable to the copper tungsten electrode due to a very small wear.

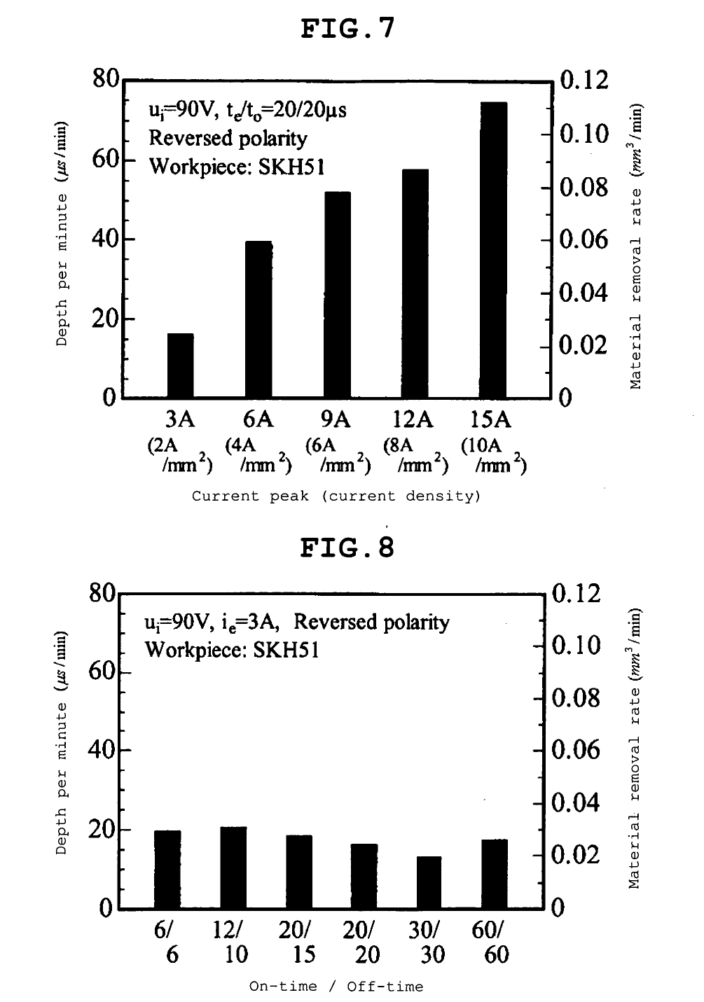

Experiments were performed to study the effect of varying current densities for the diamond electrode on the EDM efficiency. The workpiece of JIS steel SKH51 was electrical discharge machined with various current densities [A/mm²]. A reverse polarity was set, open circuit voltage uᵢ was set to 90 V, on-time tₑ and off-time tₒ were set to 20 μs, and machining time was 10 minutes. Current peak iₑ was changed to 3 A, 6 A, 9 A, 12 A and 15 A. Thus, current density was changed to 2 A/mm², 4 A/mm², 6 A/mm², 8 A/mm² and 10 A/mm². As shown in FIG. 7, depth per minute and material removal rate were increased along with the increase in current density, and a significantly high current can be supplied to the electrically-conductive diamond electrode even at density of 10 A/mm². Almost no electrode wear was observed.

Further, experiments were performed to study the effect of varying on-time and off-time for the diamond electrode on the EDM efficiency. The workpiece of JIS steel SKH51 was electrical discharge machined with various on-times and off-times. A reverse polarity was set, open circuit voltage uᵢ was set to 90 V, and machining time was 10 minutes. On-time/off-time [μs] was changed to 6/6, 12/10, 20/15, 20/20, 30/30, 60/60. As shown in FIG. 8, depth per minute and material removal rate remained constant for the different on-times/off-times. Almost no electrode wear was observed.

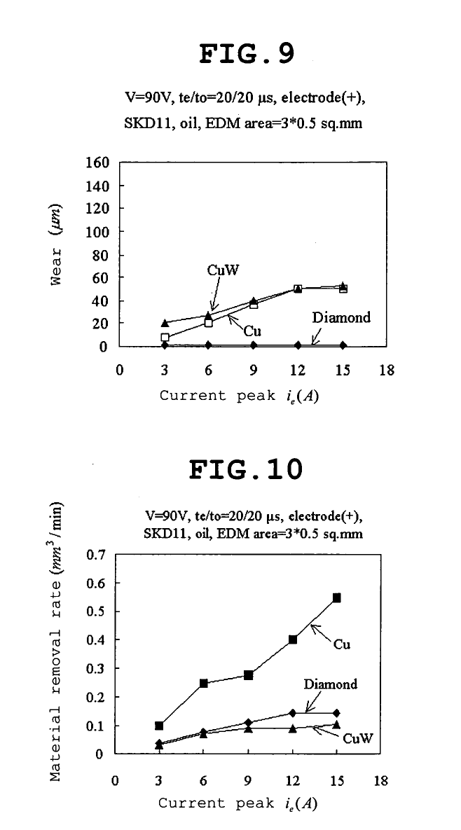

Experiments were performed to study the effect of varying current peaks for the diamond electrode on the electrode wear and EDM efficiency. The workpiece of JIS steel SKD11 was electrical discharge machined with various current peaks [A]. A reverse polarity was set, open circuit voltage uᵢ was set to 90 V, on-time tₑ and off-time tₒ were set to 20 μs, and machining time was 10 minutes. Current peak iₑ was changed to 3 A, 6 A, 9 A, 12 A and 15 A. As shown in FIG. 9, almost no wear of the electrically-conductive diamond electrode was observed with various current peaks while wears of the copper and copper tungsten electrodes were increased as current peak was increased. FIG. 10 shows that material removal rates were increased as current peak was increased.

In the above-mentioned experiments, an electrode of the present invention consists of only an electrically-conductive diamond segment. An electrode may be formed by attaching an electrically-conductive diamond to a base metal of desired shape by an appropriate electrically-conductive adhesive. If necessary, such electrode may be further formed into a desired shape by wire electrical discharge machine.

The invention has been described with particular illustrative embodiments. It is to be understood that the invention is not limited to the above-described embodiments and that various changes and modifications may be made by those of ordinary skill in the art without departing from the spirit and scope of the invention.

1. An electrode used for electrical discharge machining of a workpiece, wherein the electrode comprises electrically-conductive diamond having a maximum specific resistivity of 1×10⁻³Ω·m.

2. The electrode according to claim 1, wherein the electrically-conductive diamond further has a thermal diffusivity of at least 0.23×10⁻³ m²/s.

3. An electrode used for electrical discharge machining of a workpiece, wherein the electrode comprises boron-doped, electrically-conductive diamond.

4. A method of producing an electrode for electrical discharge machining of a workpiece, comprising the steps of:
producing a synthetic diamond by chemical vapor deposition; and
doping boron to the synthetic diamond.

5. A method of electrical discharge machining a workpiece, comprising the step of generating electrical discharge between the workpiece and an electrode, wherein the electrode comprises electrically-conductive diamond having a maximum specific resistivity of 1×10⁻³Ω·m.

6. The method of electrical discharge machining a workpiece of claim 5, wherein the electrically-conductive diamond has a thermal diffusivity of at least 0.23×10⁻³ m²/s.

7. A method of electrical discharge machining a workpiece, comprising the steps of:
forming a work gap, by positioning an electrically-conductive diamond electrode close to the workpiece; and
applying current pulse having on-time of at least 30 μs across the work gap, from a power generator;
wherein the electrode wear ratio is 1% or less.

8. The method of electrical discharge machining a workpiece according to claim 7, further comprising the steps of:
connecting the electrically-conductive diamond electrode to a positive pole of the power generator; and
connecting the workpiece to a negative pole of the power generator.
